(19) United States
(12) Patent Application Publication
(10) Pub. No.: US 2013/0340701 A1
(43) Pub. Date: Dec. 26, 2013

(54) Internal combustion engine and hand-held power tool with internal combustion engine

(71) Applicant: Andreas Stihl AG & Co. KG, Waiblingen (DE)

(72) Inventors: Clemens Klatt, Winnenden (DE); Andreas Paa, Winnenden (DE)

(73) Assignee: ANDREAS STIHL AG & CO. KG, Waiblingen (DE)

(21) Appl. No.: 13/707,643

(22) Filed: Dec. 7, 2012

(30) Foreign Application Priority Data
Dec. 7, 2011 (DE) 10 2011 120 467.2

(51) Int. Cl. F02B 63/02

(52) U.S. Cl. CPC F02B 63/02
USPC 123/193.2

(57) ABSTRACT

An internal combustion engine of a hand-held power tool has a crankcase having a circumferential wall extending in a circumferential direction of the crankcase. A crankshaft is supported so as to be rotatable about an axis of rotation within the crankcase. At least one transfer passage extends from the crankcase into the cylinder of the engine, wherein the transfer passage has an inlet port at the crankcase. At least one fuel retaining device is disposed on the circumferential wall of the crankcase. A radial direction, starting at the axis of rotation of the crankshaft and extending outwardly, extends through the at least one fuel retaining device. The at least one fuel retaining device has a depth in the radial direction and a length in the circumferential direction. The at least one fuel retaining device, relative to the radial direction, has an asymmetric cross-section in the circumferential direction.

### BACKGROUND OF THE INVENTION

The invention relates to an internal combustion engine of a hand-held power tool for driving the tool member of the power tool wherein the internal combustion engine comprises a crankcase, a crankshaft that is rotatably supported in the crankcase so as to rotate about an axis of rotation, a cylinder, and at least one transfer passage that extends from the crankcase into the cylinder. The transfer passage opens by means of an inlet port into the crankcase. The crankcase has a circumferential wall extending in the circumferential direction and the circumferential wall is provided with at least one fuel retaining device. A radial direction extends from the axis of rotation of the crankshaft through the fuel retaining device and the fuel retaining device has a depth in the radial direction and a length in the circumferential direction. The invention further relates to a power tool provided with such an internal combustion engine.

Hand-held motor-driven power tools such as cut-off machines or the like have a usual working position relative to the direction of gravity. The internal combustion engine integrated into the power tool is designed with respect to its constructive details such that it can be operated reliably in the aforementioned usual working position.

The internal combustion engine that is generally a single-cylinder engine has a crankcase, a crankshaft that is rotatably supported in the crankcase so as to rotate about an axis of rotation, a cylinder and at least one transfer passage that extends from the crankcase to the cylinder. The transfer passage opens by means of an inlet port into the crankcase and by means of an outlet port into the cylinder. In operation of the internal combustion engine a fuel/air mixture is produced and transferred from the crankcase into the cylinder by means of the transfer passage.

Under certain operating conditions it may happen that fuel precipitates from the fine mist of the fuel/air mixture and collects at the bottom of the crankcase. In usual operation of the power tool, this is not a problem as long as the fuel/air mixture flows with the desired air ratio through the transfer passage into the combustion chamber. However, it may be necessary that the operator of the hand-held power tool tilts the power tool from its usual working position to the front or to the rear in order to perform certain tasks. In such a tilted position, it may happen that the fuel that has collected at the lowermost point of the crankcase flows through the inlet port into the transfer passage. This produces an excessively rich fuel/air mixture and causes worsening of the exhaust behavior and exhaust values and can also lead to worsening of engine operation up to the point of stalling of the engine.

In order to avoid the aforementioned problems, it is proposed in U.S. Pat. No. 5,727,506 to provide flow control means at the circumferential wall of the crankcase. The flow control means are in the form of bar-shaped fuel retaining devices that have a rectangular cross-section and that extend parallel to the axis of rotation of the crankshaft. Also, the fuel retaining devices are arranged in immediate vicinity of the port of the intake passage. This arrangement is designed to impede the flow of fuel that is not atomized.

It is a disadvantage in this connection that between the fuel retaining devices and the inlet port of the transfer passage the contour of the crankcase wall remains undisturbed and fuel can collect thereat and flow into the transfer passage. Also, the prior art fuel retaining devices, as a result of their rectangular cross-section, act as collecting spaces for the fuel without the fuel that has collected thereat being able to drain in a controlled fashion and to be returned into the fuel/air mixture. As soon as a certain excessive quantity of fuel has accumulated, the retaining action of the fuel retaining devices is no longer sufficient so that the fuel drains in an undesirable way and may pass into the transfer passage.

### SUMMARY OF THE INVENTION

It is the object of the present intention to further develop an internal combustion engine of the aforementioned kind such that an undesirable passage of fuel into the transfer passage is reliably prevented in case of a positional change of the power tool.

In accordance with the present invention, this is achieved in that the fuel retaining device relative to the radial direction has an asymmetrical cross-section in the circumferential direction.

The invention has furthermore the object to provide a hand-held power tool with operational safety independent of its position.

In accordance with the present invention, this is achieved in that the power tool is provided with an internal combustion engine where the fuel retaining device relative to the radial direction has an asymmetrical cross-section in the circumferential direction.

According to the invention, it is provided that the fuel retaining device relative to the radial direction has an asymmetric cross-section with respect to the circumferential direction. Preferably, the asymmetric cross-section has a first flank that is facing away from the inlet port and a second flank that is facing the inlet port wherein the first flank relative to the radial direction at least sectionwise is positioned at a first angle with an absolute value of less than 90°, wherein the second flank relative to the radial direction is positioned at least sectionwise at a second angle with an absolute value of equal to or less than 90° and wherein the first angle is smaller than the second angle.

The aforementioned asymmetric cross-section configuration provides a direction-dependent obstructing action. The flanks that are facing away from the inlet port of the transfer passage, as a result of the smaller first angle relative to the radial direction, are steeper than the second flanks that are facing the inlet port. This causes a distinct obstructing action on the fuel accumulated within the crankcase in such a way that the fuel cannot flow to the inlet port and cannot pass into the transfer passage. Conversely, the second flanks that are facing the inlet port and, as a result of their greater angle, are significantly flatter relative to the circumferential direction exert no significant obstructing action so that fuel quantities that still have reached the area of the inlet port or the transfer passage can drain unhindered into the low lying areas of the crankcase. The fuel quantities that are accumulating thereat can then be absorbed again by the fuel/air mixture and can pass into the combustion chamber under the desired atomizing conditions in the regular undisturbed operation.

In a preferred embodiment, the first angle is in a range of including 0° up to and including 50°, preferably in a range of including 20° up to and including 40° and is in particular at least approximately 30°. The second angle is expediently in a range of including 40° up to and including 90°, preferably in a range of including 60° up to and including 80°, and is in particular at least approximately 70°. The aforementioned angle values ensure that, on the one hand, a reliable obstructing action in the direction to the inlet port of the transfer passage is provided while, on the other hand, fuel can reliably drain in the opposite direction.

In an advantageous embodiment, the first angle and the second angle extend in opposite directions when measured from the radial direction. This embodiment is easy to produced and is very effective. As an alternative, it may be expedient that the first angle and the second angle, measured from the radial direction, extend in the same direction. In this case, the flank that is facing away from the inlet port forms an undercut relative to the radial direction and this undercut enhances the retaining action for the accumulated fuel.

In an expedient embodiment, the at least one fuel retaining device extends in the radial direction across a radial depth and has, relative to the radial depth, a radial inner area that is facing the axis of rotation wherein the first angle and the second angle are measured in this radial inner area. Advantageously, the radial inner area, beginning at a radial innermost point of the fuel retaining device, extends with a radial area depth across at least 40%, preferably at least 60%, and in particular across at least 80%, of the radial depth. These values take into consideration that it is primarily the radial inner area of the fuel retaining device facing the axis of rotation that is responsible for the retaining action, on the one hand, and for the action favoring drainage in opposite direction, on the other hand. For the desired distinctive action it is thus important that the design of the flanks with regard to shape and angle position within the aforementioned radial inner area fulfills the aforementioned numerical values.

It can be expedient that the first flank and/or the second flank in the radial inner area are at least sectionwise planar or, for example, do not extend straight wherein the first angle or the second angle is averaged across the course of the radial inner area. Alternatively or in addition, it can be expedient that the first flank and/or the second flank in the radial inner area is at least sectionwise planar or extending straight wherein the first angle or the second angle is measured across the course of the planar section. Both embodiments also include the possibility that the angles as a whole, i.e., across the entire radial depth of the fuel retaining device, fulfill the aforementioned numerical and angle values. In all aforementioned cases the retaining action in one direction and the release action (drain action) in the opposite direction are ensured in such a way that a high degree of efficiency is provided.

In a preferred embodiment, the at least one fuel retaining device extends straight across at least the majority of the width and in particular across the entire width of the crankcase and extends advantageously parallel to the axis of rotation. In this way, the efficiency is further improved.

It can be expedient to provide only a single fuel retaining device. It has been found to be expedient that preferably three to 10, and in particular six, fuel retaining devices are provided. In particular, several fuel retaining devices in the circumferential direction adjoin each other immediately so that they supplement each other in regard to their action. It has been found to be useful in practice that the sum of all of the fuel retaining devices in the circumferential direction of the crankcase extends across a circumferential angle that is at least 30° and preferably at least 50°.

It can be expedient that the fuel retaining devices project in radial direction inwardly past the otherwise undisturbed inner contour of the circumferential all of the crankcase. Preferably, the at least one fuel retaining device is formed by at least one depression (recess) that is formed in the otherwise undisturbed inner contour. In this way, a minimization of the crankcase volume is achieved which is beneficial for the gas guiding action, the mixture formation, and the prevention of deposition of fuel quantities.

In the usual working position of the power tool that is employed during regular operation, the circumferential wall of the crankcase has a lowermost point relative to the direction of gravity wherein the at least one fuel retaining device, preferably all of the fuel retaining devices, are arranged between the lowermost point and the inlet port of the transfer passage. In this way, it is achieved that the fuel retaining devices develop their action immediately at the place where it is most important for reliable operation of the internal combustion engine. Between the fuel retaining devices and the inlet port of the transfer passage there are no areas remaining in which the fuel could deposit and could flow unhindered into the transfer passage without being affected by the fuel retaining devices. In this connection, preferably a retaining device is arranged immediately adjacent to the inlet port of the transfer passage.

### BRIEF DESCRIPTION OF THE DRAWING

FIG. 1 is a side view of a cut-off machine shown as an exemplary embodiment of the power tool according to the invention.

FIG. 2 is a schematic section illustration of an internal combustion engine of the power tool according to FIG. 1 with details in regard to the arrangement of the fuel retaining devices in the crankcase.

FIG. 3 shows in a schematic illustration a detail of the crankcase according to FIG. 2 with a first embodiment of a fuel retaining device in the form of a depression that extends in radial direction outwardly and is asymmetric in cross-section.

FIG. 4 is a variant of the embodiment according to FIG. 3 with an undercut depression.

FIG. 5 is a schematic illustration of a detail view of the crankcase according to FIG. 2 showing a further embodiment of a fuel retaining device in the form of a projection that projects inwardly in radial direction and is asymmetric in cross-section.

FIG. 6 is a perspective view of a cast part forming the crankcase according to FIG. 2 with details of the arrangement of several fuel retaining devices in the form of depressions.

FIG. 7 is a detail view of the fuel retaining devices according to FIG. 6 showing an end view with details of the geometric configuration.

### DESCRIPTION OF THE PREFERRED EMBODIMENTS

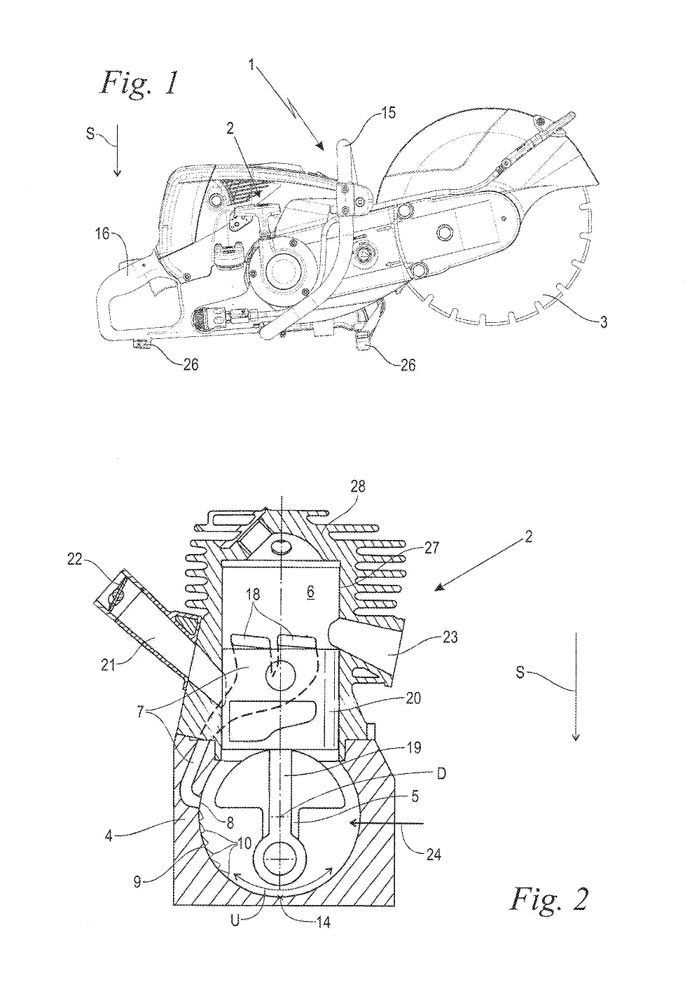

FIG. 1 is a side view of the power tool 1 according to the invention exemplified by a cut-off machine. However, a motor chainsaw, a trimmer, a hedge trimmer or the like can be used also. The power tool 1 comprises a tool member 3 which is in this case a cutter wheel and which in operation is driven by an internal combustion engine 2 arranged in the power tool 1 and illustrated in FIG. 2.

The power tool 1 comprises a front handle 15 arranged at the leading end facing the tool member 3 and a read handle 16 that is arranged at the end facing away from the tool member 3, wherein the operator lifts and guides the power tool 1 by gripping with one hand the front handle 15 and with the other hand the rear handle 16. Also, the power tool 1 is provided with legs 26 by means of which the power tool can be placed onto the ground or floor.

The power tool 1 is illustrated in its usual working position relative to the direction of gravity S. This usual working position results from relaxed lifting of the power tool 1 by holding onto both handles 15, 16 and corresponds to the position in which the power tool 1 is positioned when put down on the ground so as to rest on the legs 26. By lifting or lowering the rear handle 16, the power tool 1 can be tilted from the illustrated usual working position forwardly, causing the tool member 3 to be lowered, or rearwardly, causing the tool member 3 to be raised, inasmuch as such a tilt may be required by the task at hand.

FIG. 2 shows in a schematic section illustration the internal combustion engine 2 of the power tool 1 according to FIG. 1. The internal combustion engine 2 is a single-cylinder two-stroke engine with a crankcase 4, a crankshaft 5 rotatably supported in the crankcase 4 so as to rotate about axis of rotation D, and a cylinder 27. A connecting rod 19 is supported on the crankshaft 5 and is connected to the piston 20. The piston 20 is movable reciprocatingly in the cylinder 27 and delimits a combustion chamber 6 together with the cylinder 27 and the cylinder head 28.

At least one transfer passage 7 extends from the crankcase 4 into the cylinder 27. The at least one transfer passage 7 opens by means of an inlet port 8 at the circumferential wall 9 of the crankcase 4 into the crankcase 4 and by means of an outlet port 18 into the cylinder 27. In the illustrated embodiment, the transfer passage 7 is branched several times so that, starting at a single inlet port 8, the transfer passage 7 branches into several branch passages with a total of four outlet ports 18 wherein in the illustration according to FIG. 2 only two of a total of four outlet ports 18 are illustrated. However, a deviating configuration of the transfer passage or transfer passages 7 may be expedient. For example, it is also possible that two transfer passages 7 open with a single inlet port 8 into the crankcase 4.

For supplying the internal combustion engine 2 with fresh combustion air, an intake passage 21 with a throttle flap 22 is provided and the intake passage 21 opens into the cylinder 27. An exhaust outlet 23 extends away from the cylinder 27 for discharging exhaust gases produced by combustion. The outlet port 18 of the transfer passage 7 as well as the ports of the intake passage 21 and of the exhaust outlet 23 in the cylinder 27 are controlled by the stroke of the piston. The intake passage 21 can be designed in the area of the throttle flap 22 as a carburetor. In the illustrated embodiment, a low-pressure injection 24 is provided which is schematically indicated by an arrow. By means of this low-pressure injection, fuel is injected into the crankcase 4. The low-pressure injection 24 can be used also for injection of fuel into the intake passage 21 or into the transfer passage 7. In any case, an ignitable fuel/air mixture is formed with the combustion air that is taken in through the intake passage 21 and is supplied by means of the at least one inlet port 8, the at least one transfer passage 7, and the outlet port 18 into the cylinder 27 and is combusted in the combustion chamber 6.

The crankcase 4 has a circumferential wall 9 that extends at least approximately in the shape of a cylinder section in circumferential direction U about the axis of rotation D. The internal combustion engine 2, in accordance with its position in the power tool 1 (FIG. 1), is illustrated in its usual working position relative to the direction of gravity S so that, in the direction of gravity S, a lowermost point 14 of the circumferential wall 9 is formed below the axis of rotation D. In usual operation of the internal combustion engine 2 a complete atomization of the fuel in the taken-in combustion air is desired. Under certain operating conditions, it may happen however that a portion of the atomized fuel will precipitate and accumulate in the area of the lowermost point 14. In the illustrated usual working position, a vertical direction of the power tool 1 is parallel to the direction of gravity S. The inlet port 8 of the transfer passage 7 is then positioned, relative to the direction of gravity S, clearly above the lowermost point 14 and thus far enough above possibly collected fuel in the vertical direction. Upon tilting of the power tool 1 (FIG. 1), including the combustion engine 2, in such a way that the inlet port 8 is lowered and thus closer to the lowermost point 14, there is the risk that the fuel collected at the lowermost point 14 can flow through the inlet port 8 into the transfer passage 7 and from there into the cylinder 27.

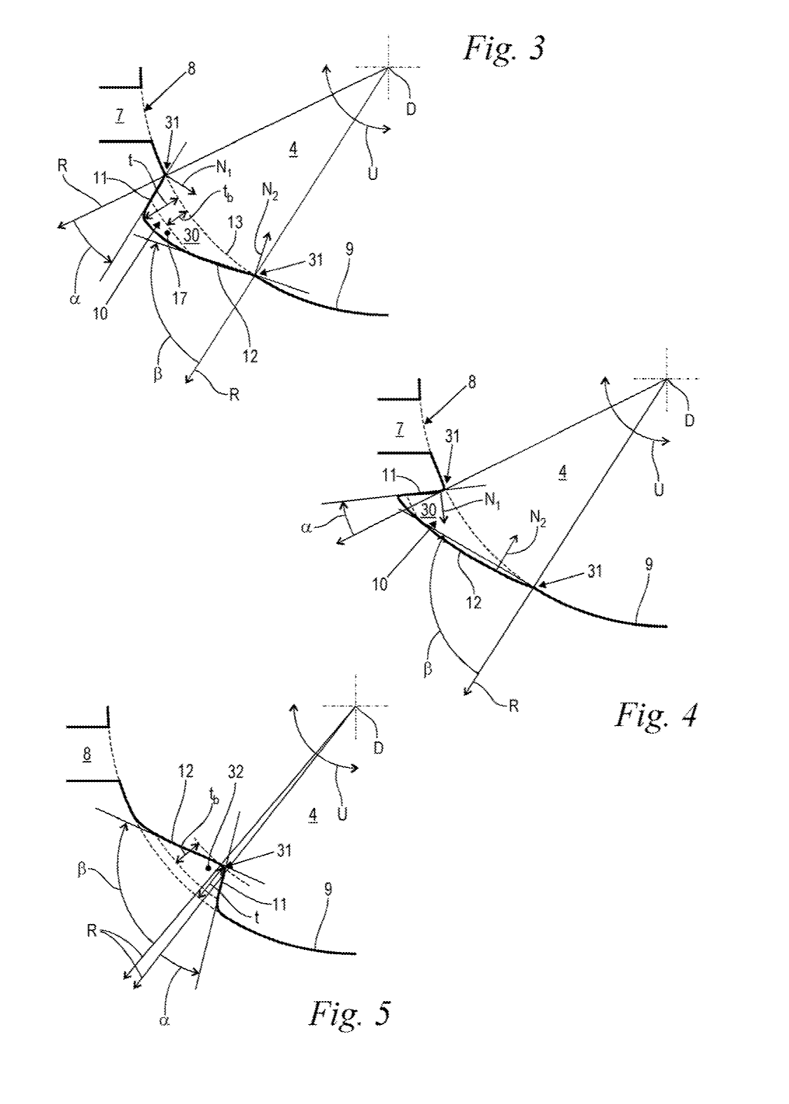

In order to prevent this situation, the circumferential wall 9 is provided with at least one, preferably several, expediently three to 10 and in the illustrated embodiment six schematically indicated fuel retaining devices 10. In the illustrated preferred embodiment, the at least one, here all fuel retaining devices 10 are arranged in the lower area of the crankcase 4, viewed in the direction of gravity S, between the lowermost point 14 and the inlet port 8 of the transfer passage 7. The fuel retaining device 10 that is closest to the inlet port 8 of the transfer passage 7 is arranged immediately adjacent to the inlet port 8. Between the individual fuel retaining devices 10 spacings can be provided. In the illustrated preferred embodiment, the fuel retaining devices 10 in the circumferential direction U of the crankcase 4 adjoin each other immediately, i.e., without a spacing. Further details in regard to the geometric configuration of the fuel retaining devices 10 in various embodiments can be taken from FIGS. 3 to 7 and the following description.

FIG. 3 shows in a schematic illustration a detail view of the crankcase 4 according to FIG. 2 with a first embodiment of at least one fuel retaining device 10 wherein, for simplifying the drawing, a single fuel retaining devices 10 is illustrated. In regard to the advantageous number and arrangement of the fuel retaining devices 10, reference is being had to the discussion above.

The circumferential wall 9 of the crankcase 4 has an undisturbed inner contour 13 which extends in circumferential direction U in the shape of a circular section or a cylinder section. The at least one fuel retaining device 10 is formed by a depression 17 formed within the undisturbed inner contour 13. This depression 17, extends, beginning at the undisturbed inner contour 13, in the radial direction R relative to the axis of rotation D outwardly with a radial depth t. The radial innermost points 31 of the fuel retaining device 10 are positioned on the undisturbed inner contour 13. The radial outermost point of the fuel retaining device 10 is formed by the bottom of the depression 17 wherein the radial depth t is measured in the radial direction R from the undisturbed inner contour 13 and thus also from the innermost point 31 to the radial outermost point, i.e, the bottom of the depression 17.

The fuel retaining device 10 extends also in the circumferential direction U, i.e., has a length in the circumferential direction. Its cross-section to the radial direction R is not mirror-symmetrical but with regard to its extension in the circumferential direction U is asymmetrical relative to the radial direction R as a reference line or reference plane. The asymmetrical cross-section of the fuel retaining device 10 has a first flank 11 that is facing away from the inlet port 8 of the transfer passage 7 and has a perpendicularly positioned normal N₁ to its flank surface and a second flank 12 that is facing the inlet port 8 and has a perpendicularly positioned normal N₂ to its flank surface. Describing the first flank 11 as facing away from the inlet port 8 means in other words that the correlated normal N₁ that extends perpendicularly away from the first flank 11 also points away from the inlet port 8 relative to the circumferential direction U. Describing the second flank 12 as facing the inlet port 8 means in other words that the correlated normal N₂ that extends perpendicularly away from the second flank 12 is oriented toward the inlet port 8 relative to the circumferential direction U.

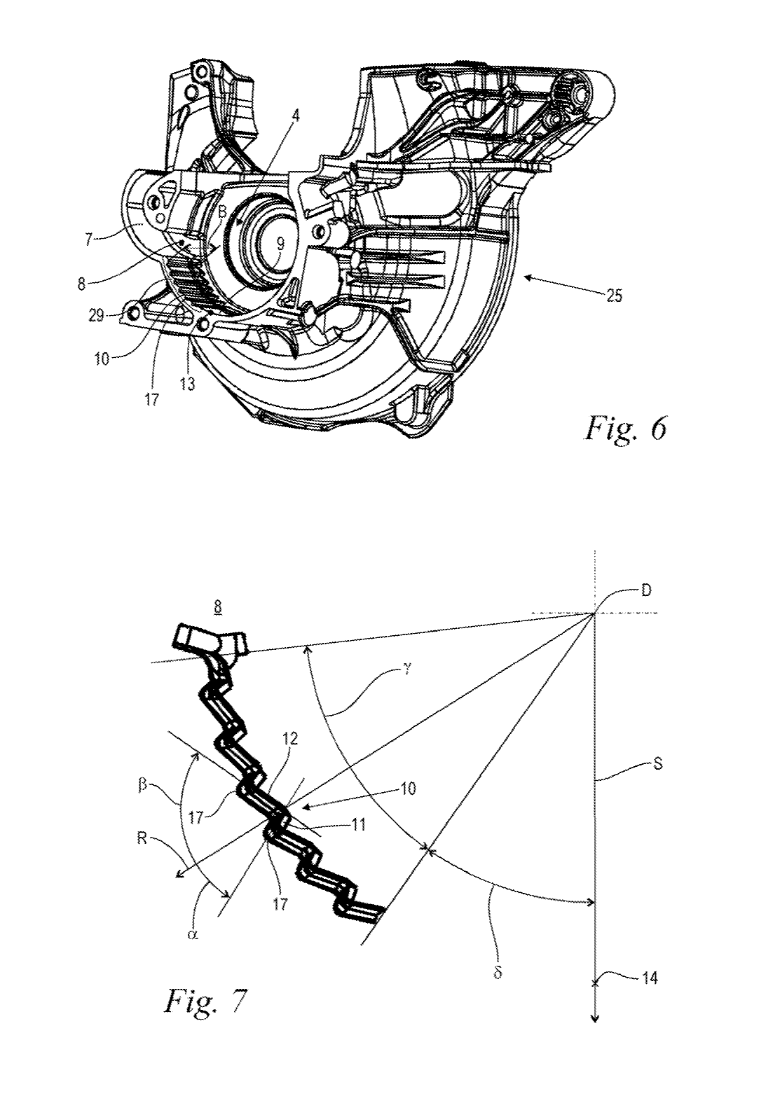

The first flank 11 is positioned relative to the radial direction R at least sectionwise at a first angle α. The first angle α is determined between the first flank 11 and the crossing radial direction R in such a way that its absolute value is less than 90°. In other words, the first angle α is determined radially outside of a crossing point of the radial direction R with the first flank 11, i.e., it is measured, starting at the radial direction R, in the direction of an extension of the first flank 11 (see FIG. 3). Inasmuch as the correlated directional arrow of the angle α relative to the circumferential direction U is facing away from the inlet port 8, the first angle α is positive. The second flank 12 is positioned relative to the radial direction R at least sectionwise at a second angle β. The second angle β is determined between the second flank 12 and the crossing radial direction R in such a way that its absolute value is smaller than or equal to 90°. In other words, the second angle β is determined outside of its crossing point with the radial direction R with the second flank 12 such that, starting at the radial direction R, it is measured toward the extension of the second flank 12 (see FIG. 3). Inasmuch as the correlated directional arrow of the angle β relative to the circumferential direction U is pointing toward the inlet port 8, the second angle β is positive. In accordance with the invention, it is provided that the first angle α is smaller than the second angle β. In the embodiments according to FIGS. 3 and 5, the first angle α and also the second angle β, starting at the radial direction R, extend thus in opposite directions with respect to the circumferential direction and measured at the radial outer side. Relative to the radial direction R, both surface normals N₁ and N₂ are oriented to the interior toward the axis of rotation D. The first angle α and also the second angle β are therefore positive in accordance with the above angle definition positive.

The at least one fuel retaining device 10 has relative to its radial depth t a radial inner area 30 which is facing the axis of rotation D. The radial inner area 30, beginning at the radial innermost point 31 of the fuel retaining device 10, extends with a radial area depth t_{b} across at least 40%, preferably at least 60%, and in particular across 80% of the radial depth t. In accordance with the illustration of FIG. 3, the radial inner area 30 is thus delimited by two dashed lines, i.e., by the undisturbed contour 13 and a further dashed line; this further dashed line is positioned in radial direction outside of the undisturbed contour 13 at a radial spacing that is identical to the radial area depth t_{b}. In the embodiment according to FIG. 3, the radial area depth t_{b} is illustrated as extending across approximately 60% of the radial depth t, for example. Since the effect of the fuel retaining device 10 that is in cross-section asymmetrical is primarily obtained in the radial inner area 30, the decisive first angle α and the decisive second angle β are measured in the radial inner area 30. Advantageous angle values in this connection are indicated in connection with FIGS. 6 and 7.

In the context of the invention, it may be expedient that the first flank 11 and/or the second flank 12 are at least section se non-planar in the radial inner area 30. Alternatively, or in addition, it may be advantageous that the first flank 11 and/or the second flank 12 in the radial inner area 30 at least sectionwise are planar. Of course, also any suitable combination of planar and non-planar portions of the first and second flanks 11, 12 are possible. Planar first and second flanks 11, 12 are described infra in connection with FIGS. 6 and 7. In the embodiments according to FIGS. 3 and 5, situations with exclusively non-planar, irregularly shaped first and second flanks 11, 12 are shown in an exemplary fashion wherein the absolute values of the first angle α and of the second angle β across the extension of the radial inner area 30 are averaged or represent an average value. In connection with planar flanks 11, 12, such an average value can be determined also. Incidentally, it is also possible to determine the first and/or second angles α, β at tangents that contact the first or second flanks 11, 12 within the inner area 30.

FIG. 4 shows a variant of the arrangement according to FIG. 3 in which the first flank 11 relative to the radial direction R is slanted to such an extent that the corresponding surface normal N₁ that is perpendicular to the first flank and oriented away from it relative to the circumferential direction U is still pointing away from the inlet port 8. In contrast to the embodiment of FIG. 3, the surface normal N₁ however is pointing, relative to the radial direction R, not inwardly to the axis of rotation D but in opposite direction in radial direction outwardly. This means that the first angle α and the second angle β extend in the same direction when measured, starting at the radial direction R, in the circumferential direction U and on the radial outer side. The first flank 11 forms relative to the radial direction R an undercut. In accordance with the definition provided in connection with FIG. 3 of a positive angle value, the first angle α in the context of the invention has a negative value while the second angle β in the context of the invention has a positive value.

In the embodiment according to FIG. 4, the radial inner area 30 is indicated as in FIG. 3 by two dashed lines, i.e., by the undisturbed inner contour 13 and, in radial direction outside thereof, by a further dashed line, wherein for the section area depth t_{b} (FIG. 3) approximately 80% of the radial depth t (FIG. 3) are illustrated in an exemplary fashion. In regard to other features, reference characters, and options, the embodiment according to FIG. 4 is identical to that of FIG. 3.

A further embodiment of the invention is shown in the schematic illustration of FIG. 5. In this embodiment, the fuel retaining device 10, in contrast to FIGS. 3 and 4, is however not a depression 17 but in the form of a projection 32. The projection 32 extends, starting at the undisturbed contour 13 of the circumferential wall 9, opposite to the radial direction R inwardly toward the axis of rotation D with a radial depth t to its innermost point 31. In respect to other features, reference characters and options, in particular with respect to the configuration of the first and second flanks 11, 12 as well as the correlated first and second angles α and β within the area depth t_{b}, the embodiment of FIG. 5 is identical to that of FIGS. 3 and 4. Of course, within the scope of the invention it is also possible to combine depressions 17 according to FIGS. 3 and 4 and projections according to FIG. 5 with each other. This encompasses also the possibility that the at least one fuel retaining device 10 relative to the radial direction R may extend in radial direction at the inner side as well as in radial direction at the outer side of the undisturbed inner contour 13 of the circumferential wall 9.

FIG. 6 shows in a perspective illustration a light metal cast part 25 for forming the arrangement according to FIG. 2 in which the crankcase 4, the lower section of the transfer passage 7 with correlated inlet port 8, as well as the fuel retaining devices 10 can be embodied as a monolithic part in accordance with FIG. 2. However, the fuel retaining devices 10 must not be monolithic within the cast part 25. Optionally, or alternatively, they can be provided as separate individual parts or can be formed on a separate insertion part 29, indicated in dashed lines, and secured on the cast part 25. The crankcase 4 has a width B in the direction of the axis of rotation D (FIG. 2). The at least one fuel retaining device 10, in this embodiment all of the fuel retaining devices 10, extend in a straight line across at least a majority of the width B and in this embodiment across the entire with B of the crankcase 4. They may be positioned at an angle relative to the axis of rotation D. In the illustrated preferred embodiment the fuel retaining devices 10 extend on a straight line parallel to the axis of rotation D (FIG. 2).

The circumferential wall 9 of the crankcase 4 has an undisturbed inner contour 13 that is in the shaped of a cylinder section. Based on this, it may be expedient that the fuel retaining devices 10, in accordance with the schematic illustration of FIG. 5, are raised relative to the undisturbed inner contour 13 and extend in radial direction inwardly. In the illustrated preferred embodiment, the fuel retaining devices 10 are formed by depressions 17 formed within the undisturbed inner contour 13 in accordance with the schematic illustration of FIG. 3 so that the radial innermost point 31 of each fuel retaining device 10 that is facing the axis of rotation D (FIGS. 3 and 7) is positioned within the surface of the undisturbed inner contour 13. Based on this, the depressions 17 formed in the undisturbed inner contour 13 extend in radial direction outwardly. The illustration according to FIG. 6 also shows that the fuel retaining devices 10 are formed solely on the circumferential wall 9 of the crankcase 4 and are located in immediate vicinity of the inlet port 8 of the transfer passage 7. The inner walls of the transfer passage 7 are smooth. However, it may also be expedient to form additional fuel retaining devices 10 on the walls of the transfer passage 7.

FIG. 7 shows in a detail end view the arrangement according to FIG. 6 in the area of the fuel retaining devices 10 in the usual working position of the power tool 1 (FIG. 1) and of the internal combustion engine 2 (FIG. 2) relative to the direction of gravity S and to the lowermost point 14 through which the direction of gravity S, starting at the axis of rotation D, is extending.

In deviation from the configuration of FIG. 3, the first flanks 11 and the second flanks 12 of each fuel retaining device 10 are at least sectionwise planar wherein the first angle α and the second angle β are measured between the radial direction R and the extension of the respective planar portion. The planar portions of the first flanks 11 and the second flanks 12 are positioned within the radial inner area 30 according to FIG. 3, not illustrated in FIG. 7, and fulfill the conditions described in connection with FIG. 3. Despite the planar portions, averaged first angles α and second angles β can be used as disclosed in connection with FIG. 3, in particular when used in connection with non-planar portions of the first flanks 11 and second flanks 12. Also, a sawtooth-shaped configuration of the fuel retaining devices 10 may be expedient in which the first flanks 11 and the second flanks 12 as a whole are planar without having non-planar portions. Also, it can be expedient to design the fuel retaining devices 10 according to FIGS. 6 and 7 in accordance with FIG. 3, 4, or 5.

The first angle α is in the embodiments according to FIGS. 2, 3, 5, 6 and 7 advantageously in a range of including 0° up to and including 50°, preferably in a range of including 20° up to and including 40°, and in the illustrated preferred embodiments according to FIGS. 6 and 7 is at least approximately 30°. In case of the negative first angle α in accordance with FIG. 4, the afore described numerical values for its absolute value apply, independent of its sign. The second angle β is in all embodiments advantageously in a range of including 40° up to and including 90°, preferably in a range of 60° up to including 80°, and is at least approximately 70° in the illustrated preferred embodiment of FIGS. 6 and 7.

The aforementioned values are illustrated in FIG. 7 for a single fuel retaining device 10 but are applicable in the same way also for all other fuel retaining devices 10 that are as a whole of identically configuration with respect to their correlated radial direction R.

The illustration of FIG. 7 also shows that the sum of all fuel retaining devices 10 in the circumferential direction of the crankcase 4 (FIG. 3) relative to the axis of rotation D extends across a circumferential angle γ that is at least 30° and preferably at least 50°. In the illustrated preferred embodiment, the sum of the fuel retaining devices 10 extends about a circumferential angle γ of approximately 55°. In the illustrated usual working position between the section that is provided with the fuel retaining devices 10 and the lowermost point 14 that is defined by the direction of gravity S an angle δ of approximately 40° remains in which no fuel retaining devices 10 are arranged; the circumferential wall 9 thus has an undisturbed contour 13 (FIG. 6) within this angular range.

The embodiments of FIGS. 1 through 7 are identical relative to each other with respect to other features and reference characters, if nothing else is expressly indicated or illustrated.

The specification incorporates by reference the entire disclosure of German priority document 10 2011 120 467.2 having a filing date of Dec. 7, 2011.

While specific embodiments of the invention have been shown and described in detail to illustrate the inventive principles, it will be understood that the invention may be embodied otherwise without departing from such principles.

What is claimed is:

1. An internal combustion engine of a hand-held power tool adapted to drive a tool member of the power tool, the internal combustion engine comprising:
a crankcase having a circumferential wall extending in a circumferential direction of the crankcase;
a crankshaft supported so as to be rotatable about an axis of rotation within the crankcase;
a cylinder;
at least one transfer passage extending from the crankcase into the cylinder, wherein the transfer passage has an inlet port at the crankcase;
at least one fuel retaining device disposed on the circumferential wall of the crankcase;
wherein a radial direction, starting at the axis of rotation of the crankshaft and extending outwardly, extends through the at least one fuel retaining device;
wherein the at least one fuel retaining device has a depth in the radial direction and a length in the circumferential direction;
wherein the at least one fuel retaining device, relative to the radial direction, has an asymmetric cross-section in the circumferential direction.

2. The internal combustion engine according to claim 1, wherein the asymmetric cross-section has a first flank that is facing away from the inlet port and a second flank that is facing the inlet port, wherein the first flank is positioned relative to the radial direction at least sectionwise at a first angle with an absolute value of less than 90°, wherein the second flank is positioned relative to the radial direction at least sectionwise at a second angle with an absolute value of fess than or equal to 90°, and wherein the first angle is smaller than the second angle.

3. The internal combustion engine according to claim 2, wherein the first angle is in a range of including 0° up to and including 50°.

4. The internal combustion engine according to claim 2, wherein the second angle is in a range of including 40° up to and including 90°.

5. The internal combustion engine according to claim 2, wherein the first angle and the second angle, measured in a direction starting at the radial direction, extend in opposite directions.

6. The internal combustion engine according to claim 2, wherein the first angle and the second angle, measured in a direction starting at the radial direction, extend in the same direction.

7. The internal combustion engine according to claim 2, wherein the at least one fuel retaining device extends in the radial direction across a radial depth and, relative to the radial depth, has a radial inner area that is positioned radially inwardly and is facing the axis of rotation, wherein the first angle and the second angle are measured in the radial inner area.

8. The internal combustion engine according to claim 7, wherein the radial inner area, beginning at a radial innermost point of the at least one fuel retaining device, has a radial area depth of at least 40%.

9. The internal combustion engine according to claim 7, wherein the first flank and the second flank in the radial inner area are non-planar at least sectionwise, wherein the first angle and the second angle are averaged across the extension of the radial inner area.

10. The internal combustion engine according to claim 7, wherein the first flank or the second flank in the radial inner area is non-planar at least sectionwise, wherein the first angle or the second angle is averaged across the extension of the radial inner area.

11. The internal combustion engine according to claim 7, wherein the first flank and the second flank in the radial inner area have at least sectionwise a planar portion, respectively, wherein the first angle and the second angle are measured across the extension of the planar portion, respectively.

12. The internal combustion engine according to claim 7, wherein the first flank or the second flank in the radial inner area has at least sectionwise a planar portion, respectively, wherein the first angle or the second angle is measured across the extension of the planar portion.

13. The internal combustion engine according to claim 1, wherein the at least one fuel retaining device extends straight across at least a majority of a width of the crankcase.

14. The internal combustion engine according to claim 11, wherein the at least one fuel retaining device extends parallel to the axis of rotation.

15. The internal combustion engine according to claim 1, wherein three to 10 of the at least one fuel retaining device are provided.

16. The internal combustion engine according to claim 15, wherein the fuel retaining devices in the circumferential direction of the crankcase adjoin each other immediately.

17. The internal combustion engine according to claim 15, wherein the sum of all of the fuel retaining devices in the circumferential direction of the crankcase extend across a circumferential angle that is at least 30°.

18. The internal combustion engine according to claim 17, wherein the circumferential angle is at least 50°.

19. The internal combustion engine according to claim 1, wherein the circumferential wall of the crankcase has an undisturbed inner contour and wherein the at least one fuel retaining device is formed by a depression formed in the undisturbed inner contour.

20. A hand-held power tool comprising an internal combustion engine and a tool member, wherein the internal combustion engine comprises a crankcase having a circumferential wall extending in a circumferential direction of the crankcase; a crankshaft supported so as to be rotatable about an axis of rotation within the crankcase; a cylinder; at least one transfer passage extending from the crankcase into the cylinder, wherein the transfer passage has an inlet port at the crankcase; at least one fuel retaining device disposed on the circumferential wall of the crankcase; wherein a radial direction, starting at the axis of rotation of the crankshaft and extending outwardly, extends through the at least one fuel retaining device; wherein the at least one fuel retaining device has a depth in the radial direction and a length in the circumferential direction; wherein the at least one fuel retaining device, relative to the radial direction, has an asymmetric cross-section in the circumferential direction, wherein the internal combustion engine is in driving connection with the tool member.

21. The power tool according to claim 20, wherein the circumferential wall of the crankcase, in a usual working position of the power tool relative to the direction of gravity, has a lowermost point and the at least one fuel retaining device is arranged between the lowermost point and the inlet port of the transfer passage.

22. The power tool according to claim 21, wherein the at least one fuel retaining device is arranged immediately adjacent to the inlet port of the transfer passage.
